(19) United States
(12) Patent Application Publication
(10) Pub. No.: US 2025/0128418 A1
(43) Pub. Date: Apr. 24, 2025

(54) IN-SITU ROBOT MATERIAL-REDUCING PROCESSING METHOD AND SYSTEM FOR HYDRAULIC TURBINE TOP COVER

(71) Applicants: China Yangtze Power Co.,Ltd., Wuhan (CN); Wuhan Digital Design and Manufacturing Innovation Center Co.,Ltd., Wuhan (CN)

(72) Inventors: Hui Liu, Wuhan (CN); Fangyu Peng, Wuhan (CN); Yichuan Ran, Wuhan (CN); Tao Wu, Wuhan (CN); Lin Zhou, Wuhan (CN); Zaiming Geng, Wuhan (CN); Ming Ma, Wuhan (CN); Jian Deng, Wuhan (CN); Xiaolong Yang, Wuhan (CN); Jingling Zhou, Wuhan (CN); Xiaoping Zhang, Wuhan (CN); Huren Zhou, Wuhan (CN)

(21) Appl. No.: 18/892,353

(22) Filed: Sep. 21, 2024

(30) Foreign Application Priority Data
Oct. 19, 2023 (CN) 2023113522297

(51) Int. Cl. B25J 9/16; B25J 19/02

(52) U.S. Cl. CPC B25J 9/1679; B25J 9/1653; B25J 19/023

(57) ABSTRACT

An in-situ robot material-reducing processing method and system for a hydraulic turbine top cover are provided. The method includes: S1, obtaining frequency response data of an end of a cutter controlled by a robot by performing an impact hammer test; S2, obtaining a modal parameter of the end of the cutter controlled by the robot by using a modal analysis software; S3, obtaining a damping matrix [C] and a stiffness matrix [K] by using a free vibration equation of a damped system; S4, establishing a dynamic model of a three-degree-of-freedom robot processing system; S5, obtaining a milling force coefficient of the cutter by performing a calibration experiment; S6, solving a dynamic equation; S7, drawing a lobe diagram of flutter stability of a milling process performed by the robot; and S8, obtaining stable milling process parameters according to the lobe diagram of flutter stability.

### CROSS-REFERENCE TO RELATED APPLICATION

This application claims priority to Chinese Patent Application No. 202311352229.7, filed on Oct. 19, 2023, which is herein incorporated by reference in its entirety.

### TECHNICAL FIELD

The disclosure relates to the field of robot processing technologies, particularly to an in-situ robot material-reducing processing method and system for a hydraulic turbine top cover.

### BACKGROUND

A top cover of a hydro-generator unit, as one of the most crucial flow-passing components of the hydro-generator unit, is constantly subject to cavitation erosion from water flow during operation of the hydro-generator unit, resulting in the formation of numerous cavitation pits on a flow surface of the top cover, and bringing significant safety hazards to the safe operation of the hydro-generator unit. During maintenance of the top cover, a cavitation erosion region needs to be removed, followed by repair welding and polishing. However, larger area and removal depth of the cavitation erosion region (taking a specific type of hydro-generator unit as an example, with a circumference of approximately 40 meters (m), a width of around 14 centimeters (cm), and a removal depth reaching 10 millimeters (mm)), combined with a shorter maintenance period (where the top cover is repaired at a power station's location instead of being returned to a factory producing the top cover), poses significant challenges to a material removal process. Traditional material removal processes, such as grinding with abrasive wheels, require a large-sized and heavy apparatus to achieve high-efficiency material removal, which is inconvenient for transportation and poses immense difficulties in construction within limited spaces on-site.

In view of this, an in-situ robot material reducing processing method and system for a hydraulic turbine top cover are provided, in which lightweight and larger load-bearing ratio robot milling technology is used to realize the high-efficiency material reduction processing in a cavitation area of the hydraulic turbine top cover. However, due to the use of the lightweight robot, the vibration caused by the robot's stiffness during operation cannot be neglected, as it will directly affect the subsequent processing quality and the utilization of cutting cutters.

### SUMMARY

A first technical problem to be solved by the disclosure is to solve the problems existing in the above background technology and provide an in-situ robot material reducing processing method for a hydraulic turbine top cover, and stable processing process parameters are obtained through a flutter stability lobe diagram.

A second technical problem to be solved by the disclosure is to provide an in-situ robot material reducing processing system for a hydraulic turbine top cover, which is used for in-situ milling processing of a large-scale hydraulic turbine top cover.

In order to address the above technical problems, the following technical solutions are provided.

In one aspect, an in-situ robot material-reducing processing method for a hydraulic turbine top cover is provided, which includes:
S1, obtaining frequency response data of an end of a cutter controlled by a robot by performing an impact hammer test;
S2, obtaining a modal parameter of the end of the cutter controlled by the robot by using a modal analysis software;
S3, obtaining a damping matrix [C] and a stiffness matrix [K] by using a free vibration equation of a damped system;
S4, establishing a dynamic model of a three-degree-of-freedom robot processing system;
S5, obtaining a milling force coefficient of the cutter by performing a calibration experiment;
S6, solving a dynamic equation;
S7, drawing a lobe diagram of flutter stability of a milling process performed by the robot; and
S8, obtaining stable milling process parameters according to the lobe diagram of flutter stability.

In an embodiment, in the step S1, when the impact hammer test is carried out, an acceleration sensor is placed at an end of a milling electric spindle facing towards the cutter, and the end of the cutter is hammered with a hammer, the acceleration sensor is configured to collect the frequency response data, and a vibration acquisition platform is configured to obtain the frequency response data from the acceleration sensor.

In an embodiment, in the step S2, the frequency response data are analyzed by the modal analysis software to obtain a frequency response function, and the modal parameter is obtained by solving the frequency response function, where the modal parameter includes a modal mass matrix [M].

In an embodiment, in the step S4, the dynamic model of three-degree-of-freedom robot processing system includes a dynamic equation of a parameter Kₓ and a parameter Cₓ established on an X axis, a dynamic equation of a parameter K_{y} and a parameter C_{y} established on a Y axis, and a dynamic equation of a parameter K_{z} and a parameter C_{z} established on a Z axis.

In an embodiment, in the step S5, a milling force coefficient matrix [K_{c}] is obtained by performing the calibration experiment.

In an embodiment, in the step S6, the dynamic equation is as follows:

$$[ M ] [ \begin{matrix}\ddot{x ( t )} \\ \ddot{y ( t )} \\ \ddot{z ( t )}\end{matrix} ] + [ C ] [ \begin{matrix}\dot{x ( t )} \\ \dot{y ( t )} \\ \dot{z ( t )}\end{matrix} ] + [ K ] [ \begin{matrix}x ( t ) \\ y ( t ) \\ z ( t )\end{matrix} ] = [ {K}_{c} ] [ \begin{matrix}x ( t ) - x ( t - T ) \\ y ( t ) - y ( t - T ) \\ - ( z ( t ) - z ( t - T ) )\end{matrix} ] ,$$

wherein [M], [C] and [K] respectively represent a modal mass matrix, the damping matrix and the stiffness matrix of the end of the cutter controlled by the robot; [K_{c}] represents a milling force coefficient matrix; t and T respectively represent a current time and a cutter tooth period; x(t)−x(t−T), y(t)−y(t−T) and z(t)−z(t−T) respectively represent dynamic cutting thicknesses generated in X, Y and Z directions.

In an embodiment, in the step S7, the dynamic equation is solved by a numerical integration method to obtain a result, and the lobe diagram of flutter stability of the milling process performed by the robot is drawn according to the result.

In an embodiment, in the step S8, after the lobe diagram of flutter stability is obtained, stable milling process parameters are determined according to the lobe diagram of flutter stability, and process parameters below a stable boundary of the lobe diagram of flutter stability are parameters in which no flutter is generated during the milling process, and the stable milling process parameters include a rotational speed of a milling electric spindle and a milling depth of the cutter.

In another aspect, an in-situ robot material-reducing processing system for a hydraulic turbine top cover is provided, the in-situ robot material-reducing processing system is configured to perform the in-situ robot material-reducing processing method for a hydraulic turbine top cover described above, and the in-situ robot material-reducing processing system includes the robot and a milling electric spindle, a free end) of the robot is provided with a six-axis force sensor, the milling electric spindle is installed on the six-axis force sensor, an fixed end of the robot is installed on a base and an output shaft of the milling electric spindle is configured for installing the cutter for milling.

In an embodiment, a vision device is installed on a side of the milling electric spindle.

The disclosure has the following beneficial effects:

1. In the disclosure, due to the adoption of lightweight robot, the rigidity of the robot is relatively poorer, and it is more prone to flutter in the milling process, which will lead to increased surface machining quality and increased cutter vibration, resulting in jamming and edge collapse of the cutter. Therefore, the lobe diagram of flutter stability is used to determine process parameters of flutter-free stable milling (i.e., the stable milling process parameters), so that the milling process can be stable under flutter-free working conditions, the machining quality and the durability of the cutter can be ensured, and the in-situ high-efficiency milling and material-reducing processing of the top cover of the hydro-generator set can be realized.

2. Through the lobe diagram of flutter stability, using the process parameters below the stable boundary for machining can suppress flutter and will not flutter. By analyzing the process parameters below the stable boundary, optimal milling process parameters can be found to improve milling efficiency.

3. The machining system adopts a six-axis force sensor and a vision device. The six-axis force sensor can collect the milling force in the milling process, and analyze the milling force through the cutter online monitoring system to judge whether the cutter is seriously worn, so as to replace the cutter in time and improve the production efficiency and machining quality. The vision device can measure the area of the top cover to be machined, and after obtaining the point cloud data, it generates the milling trajectory and the machining program and sends it to the robot, and the robot performs milling according to the generated trajectory.

### BRIEF DESCRIPTION OF DRAWINGS

FIG. 1 illustrates a flow chart for obtaining stable milling process parameters of the disclosure.

FIG. 2A through FIG. 2C illustrate graphs of frequency response data obtained during the impact hammer test of the disclosure.

FIG. 3 illustrates a schematic diagram of the dynamic model of the three-degree-of-freedom robot processing system of the disclosure.

FIG. 4 illustrates a lobe diagram of flutter stability of the disclosure.

FIG. 5 illustrates a structural diagram of a processing system of the disclosure.

FIG. 6 illustrates a schematic diagram of a processing state of the disclosure.

FIG. 7 illustrates a schematic diagram of a device connection relationship when an impact hammer test is carried out.

### REFERENCE NUMERALS

1—base; 2—robot; 21—free end; 22—fixed end; 3—six-axis force sensor; 4—milling electric spindle; 41—output shaft; 5—cutter; 51—end; 6—vision device; 7—top cover; 8—acceleration sensor; 9—hammer; 10—vibration acquisition platform.

### DETAILED DESCRIPTION OF EMBODIMENTS

The embodiments of the disclosure will be further described with reference to the accompanying drawings.

### Embodiment 1

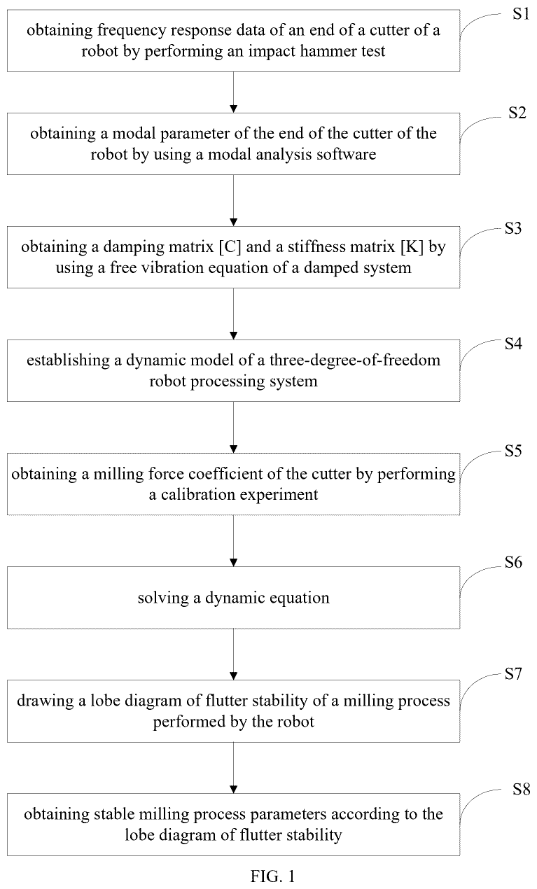

Referring to FIGS. 1-4, an in-situ robot material-reducing processing method for a hydraulic turbine top cover is provided, which includes the following steps:
S1, obtaining frequency response data of an end of a cutter controlled by a robot by performing an impact hammer test;
S2, obtaining a modal parameter of the end of the cutter controlled by the robot by using a modal analysis software;
S3, obtaining a damping matrix [C] and a stiffness matrix [K] by using a free vibration equation of a damped system;
S4, establishing a dynamic model of a three-degree-of-freedom robot processing system;
S5, obtaining a milling force coefficient of the cutter by performing a calibration experiment;
S6, solving a dynamic equation;
S7, drawing a lobe diagram of flutter stability of a milling process performed by the robot; and
S8, obtaining stable milling process parameters according to the lobe diagram of flutter stability.

Because of the lightweight robot, the robot's rigidity is relatively poorer, and it is more prone to flutter in the milling process, which will lead to increased surface machining quality and increased cutter vibration, resulting in jamming and edge collapse of the cutter. Therefore, the lobe diagram of flutter stability is used to determine process parameters of flutter-free stable milling (i.e., the stable milling process parameters), so that the milling process can be stable under flutter-free working conditions, the machining quality and the durability of the cutter can be ensured, and the in-situ high-efficiency milling and material-reducing processing of the top cover of the hydro-generator set can be realized.

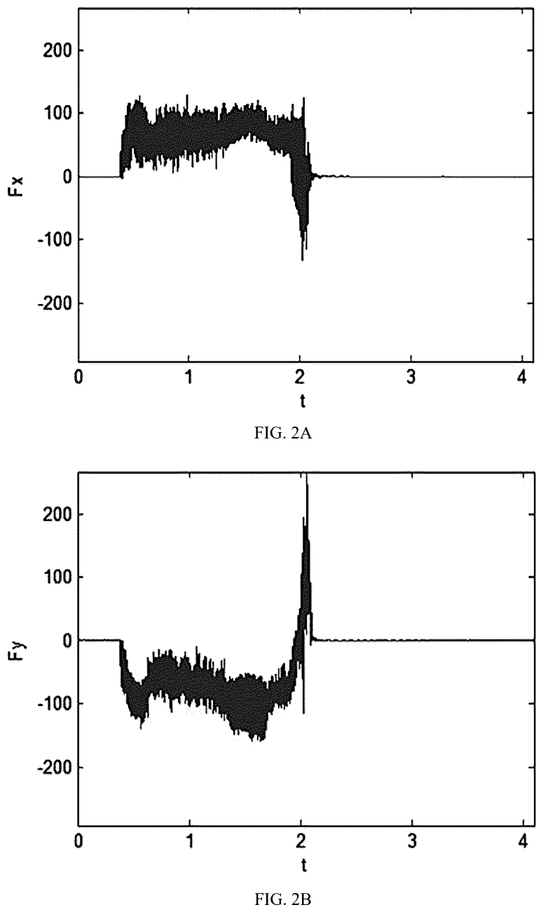

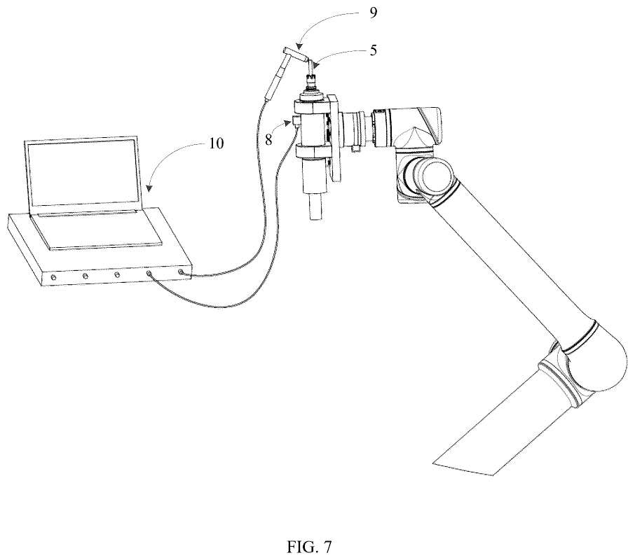

In the step S1, when the impact hammer test is carried out, as shown in FIG. 7, an acceleration sensor 8 is placed at an end of a milling electric spindle 4 near (i.e., facing towards) the cutter 5, and an end 51 of the cutter 5 is lightly hammered with a hammer 9, and the frequency response data collected by the acceleration sensor 8 is collected by using a vibration acquisition platform 10. FIG. 2A through FIG. 2C illustrate graphs of the frequency response data obtained during the impact hammer test. For example, the vibration acquisition platform 10 may be a device that can be used for high-speed data acquisition of vibration signals, which is used herein to collect frequency response data collected by the acceleration sensor 8. The vibration acquisition platform 10 may be a BVM-100-2S dual-channel vibration data collector, which is not limited herein.

In the step S2, the frequency response data are analyzed by the modal analysis software to obtain a frequency response function, and the modal parameter is obtained by solving the frequency response function, where the modal parameter includes a modal mass matrix [M]. Further, specifically, the modal analysis software is a software that can be used for modal analysis, which can be used for single-degree-of-freedom and multi-degree-of-freedom modal analysis by hammering, and can analyze collected frequency response data to obtain the frequency response function. The modal analysis software is not limited herein, as long as the corresponding function can be achieved.

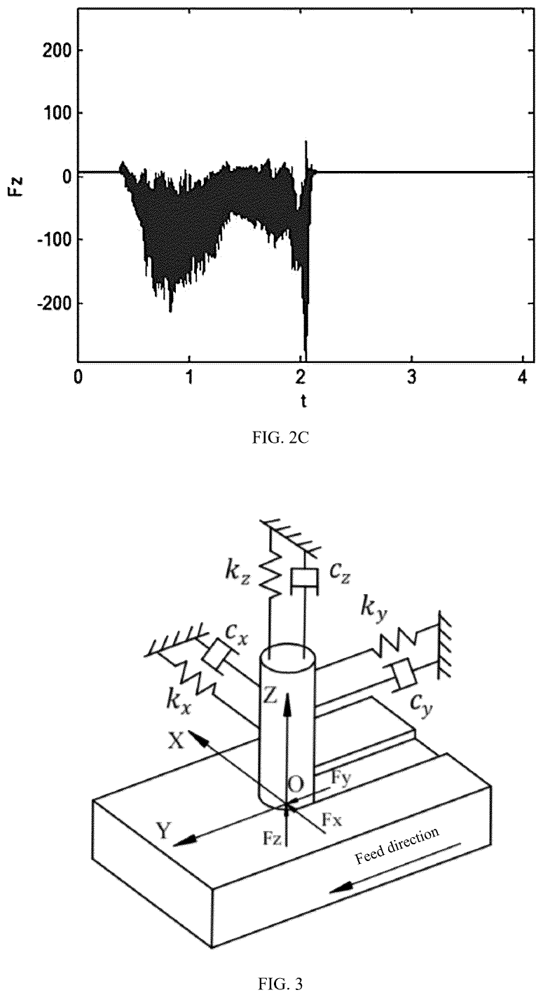

In the step S4, because the robot is lightweight, the influence of the rigidity of the robot cannot be ignored, so it is necessary to establish the dynamic model of the three-degree-of-freedom robot processing system, as shown in FIG. 3, which is a schematic diagram of the dynamic model of the three-degree-of-freedom robot processing system of the disclosure.

The dynamic model of three-degree-of-freedom robot processing system includes a dynamic equation of a parameter Kₓ and a parameter Cₓ established on an X axis, a dynamic equation of a parameter K_{y} and a parameter C_{y} established on a Y axis, and a dynamic equation of a parameter K_{z} and a parameter C_{z} established on a Z axis.

In the step S5, a milling force coefficient matrix [K_{c}] is obtained by performing the calibration experiment. The calibration experiment is performed after the cutter 5 is installed on a computer numerical control (CNC) machine cutter.

In the step S6, the dynamic equation of the three-degree-of-freedom robot processing system is as follows:

$$[ \begin{matrix}{m}_{x} & 0 & 0 \\ 0 & {m}_{y} & 0 \\ 0 & 0 & {m}_{z}\end{matrix} ] [ \begin{matrix}\ddot{x ( t )} \\ \ddot{y ( t )} \\ \ddot{z ( t )}\end{matrix} ] + [ \begin{matrix}{c}_{x} & 0 & 0 \\ 0 & {c}_{y} & 0 \\ 0 & 0 & {c}_{z}\end{matrix} ] [ \begin{matrix}\dot{x ( t )} \\ \dot{y ( t )} \\ \dot{z ( t )}\end{matrix} ] + [ \begin{matrix}{k}_{x} & 0 & 0 \\ 0 & {k}_{y} & 0 \\ 0 & 0 & {k}_{z}\end{matrix} ] [ \begin{matrix}{x}_{t} \\ {y}_{t} \\ {z}_{t}\end{matrix} ] = [ \begin{matrix}{F}_{x} \\ {F}_{y} \\ - {F}_{z}\end{matrix} ] .$$

The dynamic equation can be further simplified as:

$$[ M ] [ \begin{matrix}\ddot{x ( t )} \\ \ddot{y ( t )} \\ \ddot{z ( t )}\end{matrix} ] + [ C ] [ \begin{matrix}\dot{x ( t )} \\ \dot{y ( t )} \\ \dot{z ( t )}\end{matrix} ] + [ K ] [ \begin{matrix}x ( t ) \\ y ( t ) \\ z ( t )\end{matrix} ] = [ {K}_{c} ] [ \begin{matrix}x ( t ) - x ( t - T ) \\ y ( t ) - y ( t - T ) \\ - ( z ( t ) - z ( t - T ) )\end{matrix} ] ,$$

where [M], [C] and [K] respectively represent the modal mass matrix, the damping matrix and the stiffness matrix of the end of the cutter controlled by the robot; [K_{c}] represents the milling force coefficient matrix; t and T respectively represent a current time and a cutter tooth period; x(t)−x(t−T), y(t)−y(t−T) and z(t)−z(t−T) respectively represent dynamic cutting thicknesses generated in X, Y and Z directions.

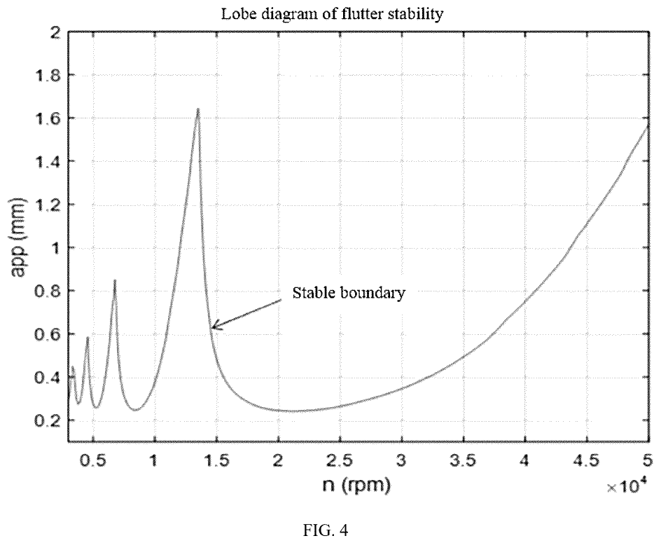

In the step S7, the dynamic equation is solved by a numerical integration method, and the lobe diagram of flutter stability of the milling process performed by the robot is drawn by a result obtained from the solution. Specifically, according to cutting conditions (such as a spindle speed, etc.), the modal parameter of the end of the cutter and the milling force coefficient, the dynamic equation is solved by the numerical integration method, to thereby obtain time-domain data such as a cutting force and a displacement of the end of the cutter. According to the time-domain data, whether the milling process is stable or not can be determined, and a critical axial cutting depth at the spindle speed can be obtained by changing an axial cutting depth independently, and the critical axial cutting depth at each spindle speed can be obtained by solving according to a certain spindle speed step. FIG. 4 is referred to, which is the lobe diagram of flutter stability obtained by the disclosure.

In the step S8, after obtaining the lobe diagram of flutter stability, flutter-free milling process parameters are determined according to the lobe diagram of flutter stability, and process parameters below a stable boundary of the lobe diagram of flutter stability are parameters in which no flutter is generated during cutting. The flutter-free milling process parameters include a rotational speed of the milling electric spindle 4 and a milling depth of the cutter 5.

In FIG. 4, process parameters below a stable boundary of the lobe diagram of flutter stability are parameters in which no flutter is generated during cutting, in which “app” represent a cutting depth. Using the process parameters below the stable boundary for machining can suppress flutter and will not flutter. By analyzing the process parameters below the stable boundary, optimal milling process parameters can be found to improve milling efficiency.

### Embodiment 2

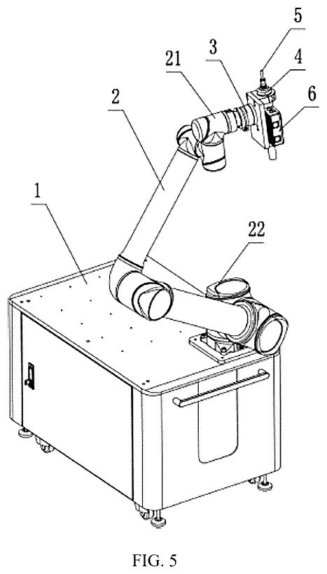

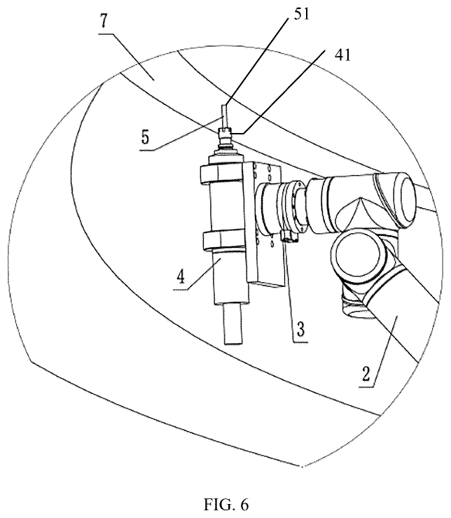

Referring to FIGS. 5 and 6, an in-situ robot material-reducing processing system for a hydraulic turbine top cover is provided, which is adopted to perform the in-situ robot material-reducing processing method for the hydraulic turbine top cover. The in-situ robot material-reducing processing system includes a robot 2 and a milling electric spindle 4. A free end 21 of the robot 2 is provided with a six-axis force sensor 3, the milling electric spindle 4 is installed on the six-axis force sensor 3, a fixed end 22 of the robot 2 is installed on a base 1, and an output shaft of the milling electric spindle 4 is configured for installing a cutter 5 for milling.

The six-axis force sensor 3 is configured to collect a milling force in a milling process, and analyze the milling force through a cutter online monitoring system to determine whether the cutter 5 is seriously worn, so as to replace the cutter 5 in time and improve production efficiency and machining quality. When the cutter 5 wears sharply, a coherence function of a force in a main cutting direction (i.e., main cutting force) and a force in a feed direction (i.e., feed force) decreases. Therefore, by monitoring the main cutting force and the feed force in real time during the milling process, the coherence function of the two is found. When the coherence function of a certain frequency band drops sharply, it shows that the cutter 5 has been seriously worn.

The base 1 can be fixed or movable.

Furthermore, a vision device 6 is installed on a side of the milling electric spindle 4. The vision device 6 is configured to measure an area to be machined of a top cover 7, and after obtaining point cloud data, generate a milling trajectory and a machining program, and send the milling trajectory and the machining program to the robot 2, and the robot 2 is configured to perform the milling process according to the generated milling trajectory.

The robot 2, the six-axis force sensor 3, the milling electric spindle 4 and the vision device 6 can be centrally controlled by a control system. The control system can be an industrial personal computer (IPC).

In this disclosure, a rigidity of a joint reducer of the robot 2 plays a decisive role in the rigidity of the whole robot 2, and a torque of the joint reducer determines a rigidity of a joint of the robot. The rigidity of the robot is poorer, and there will be a situation that the end of the robot will be deformed and lifted during the milling process, resulting in the failure to mill to a given cutting depth. Through a milling test of the robot and adjusting a torque of a joint reducer of each axis reducer of the robot, the torque of each axis reducer of the robot with a cutter diameter of 8 mm and a cutting depth of 1.5 mm (a working radius not less than 1.2 m) is determined, a rated torque of a J1/J2 axis of the robot is not less than 400 Nm, a rated torque of a J3 axis is not less than 200 Nm, and a rated torque of J4/J5/J6 axis is not less than 80 Nm.

The milling electric spindle 4 and the cutter 5 of the disclosure are suitable for top cover milling of stainless steel. The stainless steel has stronger adhesion and fusibility, and chips are easy to adhere to a cutter teeth of a milling cutter, which makes the cutting conditions worse. When ordinary end mills are used to mill stainless steel, the cutter 5 will be severely worn. Therefore, the cutter 5 adopts a milling cutter with HE coating, which has higher temperature resistance and higher coating hardness, and can effectively improve the machinability of the milling cutter. The more blades of the milling cutter, the smaller the force on each blade, but too many blades will reduce the space of the chip groove and make the chips not be discharged in time, so the cutter 5 adopts a four-blade structure. A spiral cutting edge of an end mill can change a cutting direction, so that the cutter 5 can discharge the chips smoothly when cutting, and at the same time, it can also play the role of heat dissipation and reduce cutting resistance, so reasonable selection of a spiral angle can improve the cutting performance of the milling cutter, and the cutter 5 adopts a spiral angle of 35°. The milling test of stainless steel shows that the cutter 5 has a stronger wear resistance and will not stick to the cutter during machining, which is very suitable for milling stainless steel materials with large removal.

The cutter 5 includes a spherical milling cutter and a circular nose milling cutter. Because there are side walls in a processing area of the top cover, an outer side wall is relatively higher (about 40 cm) and an inner side wall is relatively lower (about 3 cm). Therefore, in order to improve the processing efficiency and avoid collision and interference between an electric spindle and the side walls, the spherical milling cutter is adopted when processing the area near the outer side wall, and a spindle axis has a certain inclination angle relative with a processing surface, and the processing of the area near the outer side wall is realized through the spherical milling cutter while avoiding collision with the outer side wall. When machining the area near the inner side wall, circular nose milling cutters with different hanging lengths are used. With the increase of milling depth, the hanging depth of the cutter is changed to improve the machining efficiency of the area near the inner side wall.

What is claimed is:

1. An in-situ robot material-reducing processing method for a hydraulic turbine top cover, the in-situ robot material-reducing processing method comprising the following steps:
S1, obtaining frequency response data of an end of a cutter controlled by a robot by performing an impact hammer test;
S2, obtaining a modal parameter of the end of the cutter controlled by the robot by using a modal analysis software;
S3, obtaining a damping matrix [C] and a stiffness matrix [K] by using a free vibration equation of a damped system;
S4, establishing a dynamic model of a three-degree-of-freedom robot processing system;
S5, obtaining a milling force coefficient of the cutter by performing a calibration experiment;
S6, solving a dynamic equation;
S7, drawing a lobe diagram of flutter stability of a milling process performed by the robot; and
S8, obtaining stable milling process parameters according to the lobe diagram of flutter stability.

2. The in-situ robot material-reducing processing method for a hydraulic turbine top cover as claimed in claim 1, wherein in the step S1, when the impact hammer test is carried out, an acceleration sensor is placed at an end of a milling electric spindle facing towards the cutter, and the end of the cutter is hammered with a hammer, the acceleration sensor is configured to collect the frequency response data, and a vibration acquisition platform is configured to obtain the frequency response data from the acceleration sensor.

3. The in-situ robot material-reducing processing method for a hydraulic turbine top cover as claimed in claim 1, wherein in the step S2, the frequency response data are analyzed by the modal analysis software to obtain a frequency response function, and the modal parameter is obtained by solving the frequency response function, wherein the modal parameter comprises a modal mass matrix [M].

4. The in-situ robot material-reducing processing method for a hydraulic turbine top cover as claimed in claim 1, wherein in the step S4, the dynamic model of three-degree-of-freedom robot processing system comprises a dynamic equation of a parameter Kₓ and a parameter Cₓ established on an X axis, a dynamic equation of a parameter K_{y} and a parameter C_{y} established on a Y axis, and a dynamic equation of a parameter K_{z} and a parameter C_{z} established on a Z axis.

5. The in-situ robot material-reducing processing method for a hydraulic turbine top cover as claimed in claim 1, wherein in the step S5, a milling force coefficient matrix [K_{c}] is obtained by performing the calibration experiment.

6. The in-situ robot material-reducing processing method for a hydraulic turbine top cover as claimed in claim 1, wherein in the step S6, the dynamic equation is as follows:
$$[ M ] [ \begin{matrix}\ddot{x ( t )} \\ \ddot{y ( t )} \\ \ddot{z ( t )}\end{matrix} ] + [ C ] [ \begin{matrix}\dot{x ( t )} \\ \dot{y ( t )} \\ \dot{z ( t )}\end{matrix} ] + [ K ] [ \begin{matrix}x ( t ) \\ y ( t ) \\ z ( t )\end{matrix} ] = [ {K}_{c} ] [ \begin{matrix}x ( t ) - x ( t - T ) \\ y ( t ) - y ( t - T ) \\ - ( z ( t ) - z ( t - T ) )\end{matrix} ] ,$$
wherein [M], [C] and [K] respectively represent a modal mass matrix, the damping matrix and the stiffness matrix of the end of the cutter controlled by the robot; [K_{c}] represents a milling force coefficient matrix; t and T respectively represent a current time and a cutter tooth period; x(t)−x(t−T), y(t)−y(t−T) and z(t)−z(t−T) respectively represent dynamic cutting thicknesses generated in X, Y and Z directions; x(t), y(t) and z(t) respectively represent dynamic displacements of the end of the cutter in the X, Y and Z directions; \dot{x}(t), \dot{y}(t) and ż(t) respectively represent first derivatives of x(t), y(t) and z(t); and \ddot{x}(t), ÿ(t) and \ddot{z}(t) respectively represent second derivatives of x(t), y(t) and z(t).

7. The in-situ robot material-reducing processing method for a hydraulic turbine top cover as claimed in claim 1, wherein in the step S7, the dynamic equation is solved by a numerical integration method to obtain a result, and the lobe diagram of flutter stability of the milling process performed by the robot is drawn according to the result.

8. The in-situ robot material-reducing processing method for a hydraulic turbine top cover as claimed in claim 1, wherein in the step S8, after the lobe diagram of flutter stability is obtained, stable milling process parameters are determined according to the lobe diagram of flutter stability, and process parameters below a stable boundary of the lobe diagram of flutter stability are parameters in which no flutter is generated during the milling process, and the stable milling process parameters comprise a rotational speed of a milling electric spindle and a milling depth of the cutter.

9. An in-situ robot material-reducing processing system for a hydraulic turbine top cover, wherein the in-situ robot material-reducing processing system is configured to perform the in-situ robot material-reducing processing method for a hydraulic turbine top cover as claimed in claim 1, and the in-situ robot material-reducing processing system comprises the robot and a milling electric spindle, a free end of the robot is provided with a six-axis force sensor, the milling electric spindle is installed on the six-axis force sensor, an fixed end of the robot is installed on a base, and an output shaft of the milling electric spindle is configured for installing the cutter for milling.

10. The in-situ robot material-reducing processing system as claimed in claim 9, wherein a vision device is installed on a side of the milling electric spindle.

11. An in-situ robot material-reducing processing method for a hydraulic turbine top cover, the in-situ robot material-reducing processing method comprising the following steps:
S1, obtaining frequency response data of an end of a cutter controlled by a robot by performing an impact hammer test;
S2, obtaining a modal parameter of the end of the cutter controlled by the robot by using a modal analysis software according to the frequency response data;
S3, obtaining a damping matrix [C] and a stiffness matrix [K] by using a free vibration equation of a damped system;
S4, establishing a dynamic model of a three-degree-of-freedom robot processing system;
S5, obtaining a milling force coefficient matrix [K_{c}] of the cutter by performing a calibration experiment according to the damping matrix [C], the stiffness matrix [K], and a modal mass matrix [M];
S6, solving a dynamic equation by a numerical integration method to obtain a result;
S7, drawing a lobe diagram of flutter stability of a milling process performed by the robot according to the result;
S8, obtaining stable milling process parameters according to the lobe diagram of flutter stability; and
S9, performing, by the robot, the milling process on the hydraulic turbine top cover based on the stable milling process parameters.

12. The in-situ robot material-reducing processing method for a hydraulic turbine top cover as claimed in claim 11, wherein in the step S1, when the impact hammer test is carried out, an acceleration sensor is placed at an end of a milling electric spindle facing towards the cutter, and the end of the cutter is hammered with a hammer, the acceleration sensor is configured to collect the frequency response data, and a vibration acquisition platform is configured to obtain the frequency response data from the acceleration sensor.

13. The in-situ robot material-reducing processing method for a hydraulic turbine top cover as claimed in claim 12, wherein in the step S2, the frequency response data are analyzed by the modal analysis software to obtain a frequency response function, and the modal parameter is obtained by solving the frequency response function, wherein the modal parameter comprises the modal mass matrix [M].

14. The in-situ robot material-reducing processing method for a hydraulic turbine top cover as claimed in claim 13, wherein in the step S4, the dynamic model of three-degree-of-freedom robot processing system comprises a dynamic equation of a parameter Kₓ and a parameter Cₓ established on an X axis, a dynamic equation of a parameter K_{y} and a parameter C_{y} established on a Y axis, and a dynamic equation of a parameter K_{z} and a parameter C_{z} established on a Z axis.

15. The in-situ robot material-reducing processing method for a hydraulic turbine top cover as claimed in claim 14, wherein in the step S6, the dynamic equation is as follows:
$$[ M ] [ \begin{matrix}\ddot{x ( t )} \\ \ddot{y ( t )} \\ \ddot{z ( t )}\end{matrix} ] + [ C ] [ \begin{matrix}\dot{x ( t )} \\ \dot{y ( t )} \\ \dot{z ( t )}\end{matrix} ] + [ K ] [ \begin{matrix}x ( t ) \\ y ( t ) \\ z ( t )\end{matrix} ] = [ {K}_{c} ] [ \begin{matrix}x ( t ) - x ( t - T ) \\ y ( t ) - y ( t - T ) \\ - ( z ( t ) - z ( t - T ) )\end{matrix} ] ,$$
wherein [M], [C] and [K] respectively represent the modal mass matrix, the damping matrix and the stiffness matrix of the end of the cutter controlled by the robot; [K_{c}] represents the milling force coefficient matrix; t and T respectively represent a current time and a cutter tooth period; x(t)−x(t−T), y(t)−y(t−T) and z(t)−z(t−T) respectively represent dynamic cutting thicknesses generated in X, Y and Z directions; x(t), y(t) and z(t) respectively represent dynamic displacements of the end of the cutter in the X, Y and Z directions; \dot{x}(t), \dot{y}(t) and ż(t) respectively represent first derivatives of x(t), y(t) and z(t); and \ddot{x}(t), ÿ(t) and \ddot{z}(t) respectively represent second derivatives of x(t), y(t) and z(t).

16. The in-situ robot material-reducing processing method for a hydraulic turbine top cover as claimed in claim 15, wherein in the step S8, after the lobe diagram of flutter stability is obtained, stable milling process parameters are determined according to the lobe diagram of flutter stability, and process parameters below a stable boundary of the lobe diagram of flutter stability are parameters in which no flutter is generated during the milling process, and the stable milling process parameters comprise a rotational speed of a milling electric spindle and a milling depth of the cutter.

17. The in-situ robot material-reducing processing method for a hydraulic turbine top cover as claimed in claim 11, wherein the in-situ robot material-reducing processing method is performed by an in-situ robot material-reducing processing system comprising the robot and a milling electric spindle, a free end of the robot is provided with a six-axis force sensor, the milling electric spindle is installed on the six-axis force sensor, an fixed end of the robot is installed on a base, and an output shaft of the milling electric spindle is configured for installing the cutter for milling.

18. The in-situ robot material-reducing processing method for a hydraulic turbine top cover as claimed in claim 17, wherein a vision device is installed on a side of the milling electric spindle.

19. The in-situ robot material-reducing processing method for a hydraulic turbine top cover as claimed in claim 17, wherein the six-axis force sensor is configured to collect a milling force in the milling process, and analyze the milling force to determine whether the cutter is seriously worn.

20. The in-situ robot material-reducing processing method for a hydraulic turbine top cover as claimed in claim 18, wherein the vision device is configured to measure an area to be machined of a hydraulic turbine top cover, and generate a milling trajectory and a machining program, and send the milling trajectory and the machining program to the robot, and the robot is configured to perform the milling process according to the milling trajectory.
